(19) United States
(12) Patent Application Publication
(10) Pub. No.: US 2015/0321948 A1
(43) Pub. Date: Nov. 12, 2015

(54) METHOD AND SYSTEM FOR COATING GLASS EDGES

(71) Applicants: Donald Orrin BIGELOW, Honeoye Falls, NY (US); Thomas COLLER, Honeoye Falls, NY (US); Scott W. DEMING, Elmira, NY (US); Curtis Robert FEKETY, Corning, NY (US); Mark Stephen FRISKE, Campbell, NY (US); Gregory William KEYES, Rochester, NY (US); Hongkyu KIM, Old Bridge, NJ (US); Hideki MASAKI, Painted Post, NY (US); Michael George Shultz, (US); Ian David TRACY, Corning, NY (US); CORNING INCORPORATED, Corning, NY (US)

(72) Inventors: Donald Orrin Bigelow, Honeoye Falls, NY (US); Thomas Charles Coller, Honeoye Falls, NY (US); Scott Winfield Deming, Elmira, NY (US); Curtis Robert Fekety, Corning, NY (US); Mark Stephen Friske, Campbell, NY (US); Gregory William Keyes, Rochester, NY (US); Hongkyu Kim, Old Bridge, NJ (US); Hideki Masaki, Corning, NY (US); Michael George Schultz, Lowman, NY (US); Ian David Tracy, Corning, NY (US)

(21) Appl. No.: 14/648,008

(22) PCT Filed: Nov. 21, 2013
(86) PCT No.: PCT/US13/71172

§ 371 Date: May 28, 2015

Related U.S. Application Data
(60) Provisional application No. 61/730,534, filed on Nov. 28, 2012.

(51) Int. Cl. C03C 17/32; B05C 11/04; B05C 13/00; B05C 1/02

(52) U.S. Cl. CPC C03C 17/32; B05C 1/027; B05C 11/048; B05C 13/00; C03C 2218/114; C03C 2218/118; C03C 2218/365; C03C 2217/78

(57) ABSTRACT

A process and system for applying coating materials to glass edges of various profiles. The glass edge is coated by picking up the coating material from an applicator such as, for example, a roller, through precise independent or relative control of the spatial relationship between the edge of the glass article and the applicator to achieve desirable product attributes such as coating thickness, profile, coverage areas and consistency. Such spatial relationships include the gap distance between the roller and applicator, coating thickness on the applicator, applicator and/or glass speed, and the like.

This application claims the benefit of priority under 35 U.S.C. §119 of U.S. Provisional Application Ser. No. 61/730,534 filed on Nov. 28, 2012 the content of which is relied upon and incorporated herein by reference in its entirety.

### BACKGROUND

The disclosure relates to a glass article having a protective edge coating. More particularly, the disclosure relates to systems and methods of depositing such a coating.

Glass is extremely strong in its freshly manufactured state. However, this strength rapidly deteriorates as the surface becomes flawed through contact with other surfaces or when the glass becomes scratched, abraded, or impacted and chipped. Such damaging contact may be avoided if surfaces—i.e., faces and/or edges of the glass—are covered with a protective material such as, for example, adhesive plastic or paper materials, and polymer films.

Small to medium size electronic devices such as cell phones, e-book readers, electronic notepads, and notebook and laptop computers often incur potentially damaging impact during use. Glass articles incorporated into such devices are typically cut from large sheets to maximize efficiency and material utilization. However, the cutting process may introduce new flaws or expose weaker areas of the glass that were previously strengthened with processes such as tempering or ion exchange. In particular, the newly formed edges of the glass are susceptible to such damage.

Several techniques for strengthening the edge of the glass already exist. One approach has been to strengthen the edges of the glass article by acid etching. Other methods include the use of polymer over-moldings, machinable metal armor layers, polymer tapes and liquid polymers, or shaped fibers to protect the edges.

### SUMMARY

The present disclosure provides a process and system that for precisely applying coating materials to glass edges of various profiles, such as bull-nosed (rounded), chamfered, or other shapes. The applied coating has uniform thickness around the perimeter of the glass article, with little or no overflow beyond the transition from the edge onto the major surfaces of the glass article. The edge coating is non-apparent (i.e., has the appearance of no coating present on the edges), and visually, physically, and optically matches the transmission of full or partial wavelengths of the glass.

The coating of the glass edge is accomplished by picking up the coating material from an applicator such as, for example, a roller, through precise independent or relative control of the spatial relationship between the edge of the glass article and the applicator to achieve desirable product attributes such as coating thickness, profile, coverage area, and consistency. Such spatial relationships include the gap distance between the roller and applicator, coating thickness on the applicator, applicator and/or glass speed, and the like.

Accordingly, one aspect of the disclosure is to provide a method of coating an edge of at least one glass article having a first surface, a second surface, and an edge joining the first surface and the second surface, wherein the edge defines the perimeter of the glass article. The method comprises applying a layer of the coating material to a surface of at least one applicator; contacting the edge of the glass article with the coating material; and articulating at least one of the glass article and the at least one applicator to coat the edge with the coating material.

A second aspect of the disclosure is to provide a method of coating an edge of at least one glass article with a curable resin. The glass article has a first surface, a second surface, and an edge joining the first surface and the second surface, with the edge defining the perimeter of the glass article. The method comprises: determining a perimeter shape of the glass article; applying a layer of the curable resin to a surface of at least one applicator; contacting the edge of the glass article with the layer of the curable resin on the surface of the applicator; and continuously articulating at least one of the glass article and the applicator based upon the perimeter shape to coat the edge with the curable resin.

A third aspect of the disclosure is to provide a system for depositing a coating on at least one edge of at least one glass article. The system comprises a coating application station that includes at least one applicator having a surface that is adapted to hold a coating material; and a holder adapted to hold and support at least one glass article such that the at least one edge contacts the coating material. At least one of the applicator and the holder is capable of articulation in at least one of a horizontal direction, a vertical direction, and about an axis of rotation.

These and other aspects, advantages, and salient features will become apparent from the following detailed description, the accompanying drawings, and the appended claims.

### BRIEF DESCRIPTION OF THE DRAWINGS

FIG. 1a is a schematic perspective view of a glass article having a planar shape;

FIG. 1b is a schematic perspective view of glass articles having different edge profiles;

FIG. 2 is a flow chart for a method of coating a glass article;

FIG. 3 is a schematic representation of a system for coating at least one edge of a glass article;

FIGS. 4a and 4b are schematic side views of coating station B n FIG. 3, showing possible modes of articulation of the glass article

FIG. 5a is a schematic side view of a coating deposited on an edge having a bull nose edge profile;

FIG. 5b is a schematic side view of a coating deposited on an edge having a c-chamfer edge profile;

FIG. 5c is a schematic side view of a coating deposited on an edge having a flat edge profile;

FIG. 6 is a schematic side view of a method for coating a glass article having a bullnose edge profile;

FIG. 7 is a schematic side view of a method for coating a glass article having a c-chamfered edge profile;

FIGS. 8a and 8b are schematic side views of a method for coating a glass article having a flat edge profile; and

FIG. 9 is a schematic side view showing a second type of applicator/roller for applying coating material to a glass article having a flat edge profile.

### DETAILED DESCRIPTION

In the following description, like reference characters designate like or corresponding parts throughout the several views shown in the figures. It is also understood that, unless otherwise specified, terms such as “top,” “bottom,” “outward,” “inward,” and the like are words of convenience and are not to be construed as limiting terms. In addition, whenever a group is described as comprising at least one of a group of elements and combinations thereof, it is understood that the group may comprise, consist essentially of, or consist of any number of those elements recited, either individually or in combination with each other. Similarly, whenever a group is described as consisting of at least one of a group of elements or combinations thereof, it is understood that the group may consist of any number of those elements recited, either individually or in combination with each other. Unless otherwise specified, a range of values, when recited, includes both the upper and lower limits of the range as well as any ranges therebetween. As used herein, the indefinite articles “a,” “an,” and the corresponding definite article “the” mean “at least one” or “one or more,” unless otherwise specified. It also is understood that the various features disclosed in the specification and the drawings can be used in any and all combinations.

As used herein, the terms “glass” and “glasses” includes both glasses and glass ceramics. The terms “glass article” and “glass articles” are used in their broadest sense to include any object made wholly or partly of glass and/or glass ceramic.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

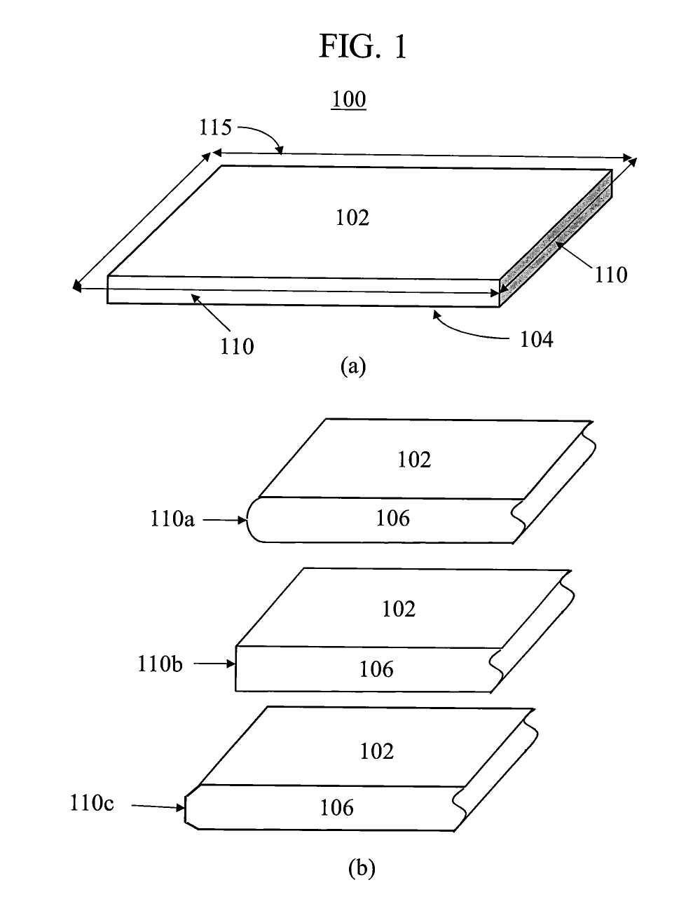

Referring to the drawings in general and to FIG. 1 in particular, it will be understood that the illustrations are for the purpose of describing particular embodiments and are not intended to limit the disclosure or appended claims thereto. The drawings are not necessarily to scale, and certain features and certain views of the drawings may be shown exaggerated in scale or in schematic in the interest of clarity and conciseness.

Described herein are a method and system for precisely applying coating materials to the edges of glass articles. The edge of the glass article may have one of various profiles such as, but not limited to, bullnose, chamfered, and flat profiles. The coating applied to the edge typically has a substantially uniform thickness around the perimeter—as defined by the edge—of the glass article. In some embodiments, the coating does not extend beyond the edge to overlap or otherwise impinge on the major surfaces of the glass article. In other embodiments, the coating is visually or physically “non-apparent;” i.e., the coating optically matches the transmission of full or partial wavelengths to that of the glass.

A glass article having a planar shape is schematically shown in perspective view in FIG. 1a. Glass article 100 has two major surfaces 102, 104 (not shown) joined by at least one edge 110. The at least one edge 110 forms a perimeter 115 around glass article 100. References to the various views of the glass article 100 will be made according to the schematic perspective view shown in FIG. 1b. A flat view of glass article 100 is one in which either of major surfaces 102, 104 are viewed directly or straight on; i.e., the point of view is perpendicular to either one of major surfaces 102, 104. An edge view is one in which an edge 110 is viewed directly or straight on; i.e., the point of view is perpendicular to edge 110. A side view is one in which the cross-section 106 of glass article 110 is viewed straight on; i.e., the point of view is perpendicular to the cross-section 106. While the glass article 100 shown in FIGS. 1a and 1b is a flat quadrilateral shape, it will be appreciated by those skilled in the art that the glass article may also have a three-dimensional shape such as for example, a convex/concave shape or a dish-like curvilinear shape. In addition, it will be appreciated that glass article may assume other multilateral shapes; e.g., hexagonal, octagonal, etc., or have rounded corners.

Edge 110 may be finished to a predetermined edge profile by any combination of finishing techniques know in the art, including, but not limited to, mechanical or laser cutting, grinding, lapping, polishing, and the like. Schematic cross-sectional views of three types of edge profiles are shown in FIG. 1b. These profiles include chamfered (also referred to herein as “c-chamfered”) 110a, flat 110b, and bull-nose 110c. It will be appreciated by those skilled in the art that the at least one edge 110 may have edge profiles other than the three edge profiles shown in FIG. 1b. Edge 110, for example, may have an edge profile comprising both chamfers and a bull-nose shape, or a knife edge or “modified bullnose” shape.

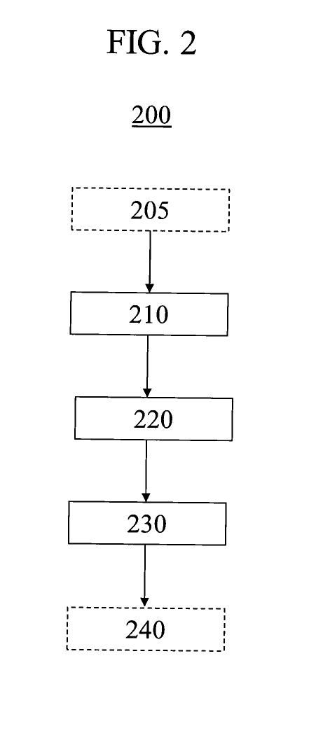

A flow chart outlining the methods described herein is shown in FIG. 2. In the first step 210 of method 200, a layer of a coating material is applied to the surface of at least one applicator (referred to herein as “the applicator surface”) to form a layer of the coating material on the applicator surface. The coating material may comprise a curable (i.e., either thermally or radiation) resin. In some embodiments, the curable resin may comprise a filler or a second material such as, for example, spherical silica nanoparticles, that may serve to improve the durability and/or adhesion of the coating when cured.

In some embodiments, the compositions of the coating material are based on urethane (meth)acrylate oligomer(s) or epoxy resins that contain nano-size inorganic particles such as, for example, silica nanoparticles. The coating compositions may be formulated to cure either optically clear or substantially transmissive to light wavelengths in one or more of the infrared (“IR”), visible, and ultraviolet (“UV) wavelength ranges. In one embodiment, the coating compositions are UV curable compositions. Table 1 describes a representative, non-limiting UV-curable epoxy coating and Table 2 describes a representative, non-limiting UV-curable urethane (meth)acrylate oligomeric coating composition. Using the method and device(s) described herein, the coating materials may have a viscosity in the range of 300 cps to 10000 cps. The epoxy based UV-curable material may either be clear or colored, and has a viscosity in the range of 3 00 cps to 10000 cps. The urethane based UV-curable material may either be clear or colored, and has a viscosity in the range of 300 cps to 10000 cps.

TABLE 1
Representative UV-curable epoxy coating materials.

| Percent by | Material Trade | |
|---|---|---|
| weight | Name | Material Chemical Type |
| 48.00 | Nanopox C-620 | Cycloaliphatic epoxy resin containing |
| | | 40 wt % 20 nm spherical silica |
| | | nanoparticles |
| 48.00 | Nanopox C-660 | Oxetane monomer containing 50 wt % |
| | | 20 nm spherical silica nanoparticles |
| 1.00 | Cyacure UVI-697 E | Cationic photo initiator |
| 2.00 | Silquest A-186 | Silane adhesion promoter |

TABLE 2
Representative UV-curable urethane (meth)acrylate
oligomeric coating composition.

| Percent by | Material Trade | |
|---|---|---|
| weight | Name | Material Chemical Type |
| 44.00 | CN9009 | Aliphatic urethane acrylate oligomer |
| 50.00 | 16046-27-1 | Acrylic monomer containing 30 wt % |
| | | 20 nm spherical silica nanoparticles |
| 3.00 | Irgacure 184 | Photoinitiator |
| 3.00 | APTMS | Silane adhesion promoter |

In some embodiments, the coating material is applied to the surface of the applicator in Step 210 by applying the coating material precisely to the applicator. In one embodiment, the applicator is a cylindrical roller. The applicator/roller may have a surface that is shaped to present a desired bead shape of the coating material to the at least one edge 110. In addition, the applicator/roller may be shaped so as to apply a minimal amount of coating material to the edge of the glass article, thereby preventing the flow of excess coating material beyond the edge to the major surfaces of the article. The application of the coating material to the applicator may be precisely controlled by a doctor blade or other feed systems know in the art so as to maintain a desired or predetermined shape, thickness, width, and shape of the coating material on the applicator surface. To accomplish this, the doctor blade may have a flat or an otherwise shaped blade. A shaped doctor blade may be used to generate a smooth, stable, and thin thickness of the coating material. In addition, a shaped doctor blade may be used to force bubbles away from the application point of the coating point.

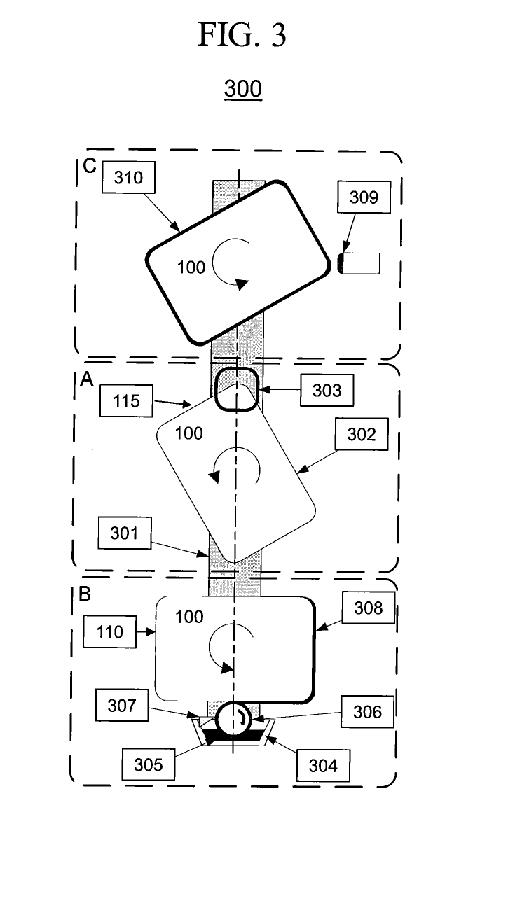

In the next step (Step 220) of method 200, at least one of the glass article 100 and the applicator surface is articulated such that the at least one edge 110 is brought into contact with the coating material that has been applied to the applicator surface to coat the at least one edge. Either single or multiple applicators may be used to apply the coating material to the glass article. In the embodiment shown in FIG. 3, the applicator remains stationary while the glass article is articulated over the applicator. The glass article is rotated and moved vertically to present a coating point on the at least one edge 110 that is geometrically tangent between the at least one edge 110 of the glass being coated and the applicator surface. In other embodiments, the applicator surface and/or applicator is articulated while the glass article 100 remains stationary. In still other embodiments, both the glass article 100 and applicator surface and/or applicator are simultaneously articulated. In some embodiments, either the applicator or the glass article is articulated by means of a pivoting arm. Neither the glass article 100 nor the at least one edge 110 contacts the applicator; i.e. a predetermined gap or distance between the at least one edge 110 and the applicator surface is maintained. Instead, the at least one edge 110 of the glass article 100 is partially dipped into the layer of coating material that is present on the applicator surface (i.e., the predetermined gap between the at least one edge 110 and the applicator surface is less than or equal to the thickness of the layer of coating material on the applicator surface). In some embodiments, the glass article is articulated without interruption such that the at least one edge is continuously in contact with the coating material on the applicator surface.

In some embodiments, method 200 further includes a step in which the coating material is cured to form the final protective coating on the at least one edge (Step 230). Such curing may include thermal curing or curing by exposure to radiation such as, for example, ultraviolet radiation. In some embodiments, Step 230 includes spot curing of the coating applied to the at least one edge 110 using, for example, an optical guide from a radiation (e.g., UV light) source. The spot may be held at a stationary position while the glass article 100 is rotated so that the coating on the entire perimeter of the at least one edge 110 is eventually illuminated and an adequate cure level is achieved. Alternatively, a light bar surrounding the perimeter 115 of glass article 100 or a broad flood lamp may provide curing of the coating material applied to the at least one edge 110.

In some embodiments, method 200 may further comprise characterizing the perimeter 115 of glass article 100 (Step 205 in FIG. 2) prior to application of the coating material to the at least one edge 110. The precise characterization of the perimeter 115 may, in some embodiments, be used to drive/determine the motion necessary to maintain the proper relationship (e.g., predetermined gap) between the applicator surface and the at least one edge 110 during the coating process. Method 200 may also further comprise a second characterization step 240 in which the perimeter is again characterized after curing the coating on the at least one edge. Step 240 may be used in conjunction with step 205 to determine the thickness of the coating applied to the at least one edge after curing (i.e., the final thickness of the cured coating).

A frontal view of one embodiment of a system used to coat the glass article is schematically shown in FIG. 3. The system 300 shown in FIG. 3 includes a visual inspection station A, a coating station B, and a curing Station B. In the embodiment shown in FIG. 3, the three stations are aligned with a linear slide 301, which allows the glass article to be moved from one station to another. The glass article 100 is mounted on a movable holder (not shown) such that the at least one edge of the glass article is presented in an unobstructed fashion to the coating material that is present on the surface of the applicator. In the system shown in FIG. 3, the glass article 100 is secured to the movable holder and oriented such that the major surfaces of the glass article are parallel to the plane of the figure. The movable holder is capable of at least one of vertical, horizontal, and rotational motion. The movable holder may use those means known in the art for holding and securing such articles during the entire coating process. Such means include, but are not limited to, vacuum cups, adhesive tapes, glues or pads, and the like.

Station A is a visual inspection station, which may also be used as a loading and unloading station for the glass article 100 before and after coating, respectively. Station A, in some embodiments, includes a vision system 303 that is used to characterize the perimeter 115 of the glass article 100 as the glass article 100 rotates about axis a. The vision system may include cameras, optical sensors, and the like that may be used to precisely determine the edge profile and perimeter dimensions, thus ensuring that proper distance is between the edge of the glass article, applicator, and/or applicator surface is maintained throughout the entire coating process. Characterization of the perimeter 115 at station A may occur before coating (step 205 in FIG. 2) and/or after coating and curing (step 240 in FIG. 2) to determine the thickness of the final coating, as well as any other attributes that may be captured by the vision system.

In the embodiment shown in FIG. 3, coating station B includes a vessel 304 that contains the coating material 305 and a rotating coating roller 306. Coating material 305 is picked up by the coating roller 306 and is metered by a doctor blade/opening 307. In station B, the rotational axis of the glass article 100 is aligned with the rotational axis of the coating roller 306. The glass article 100 is rotated and moved vertically to coat/cover the at least one edge 110 along the entire perimeter 115 with the coating material.

In some embodiments, multiple glass articles may be coated simultaneously. Here, multiple articles are stacked so that the major surfaces of the individual articles in the stack are parallel to each other and the edges of the articles are presented to the coating material on the applicator surface. Interleaves may be placed between adjacent articles to prevent contact damage and/or hold the stacked articles together in a proper relationship. Interleaf materials may include, but are not limited to, adhesive polymeric materials, low friction (e.g., Teflon®), magnetic sheets, and the like. Applicators such as pin striping or slotted rollers may be used to coat the edges of the stacked articles while preventing overflow of the coating material onto the major surfaces of the glass articles.

Instead of using a single control point on the applicator, the coating of the glass article is accomplished using various surface positions of the applicator as control sites. Based on the dimensions of the applicator and the shape data acquired for the glass article during visual inspection, the control point of the applicator is determined/calculated such that the application point for the coating material is tangent to the control point.

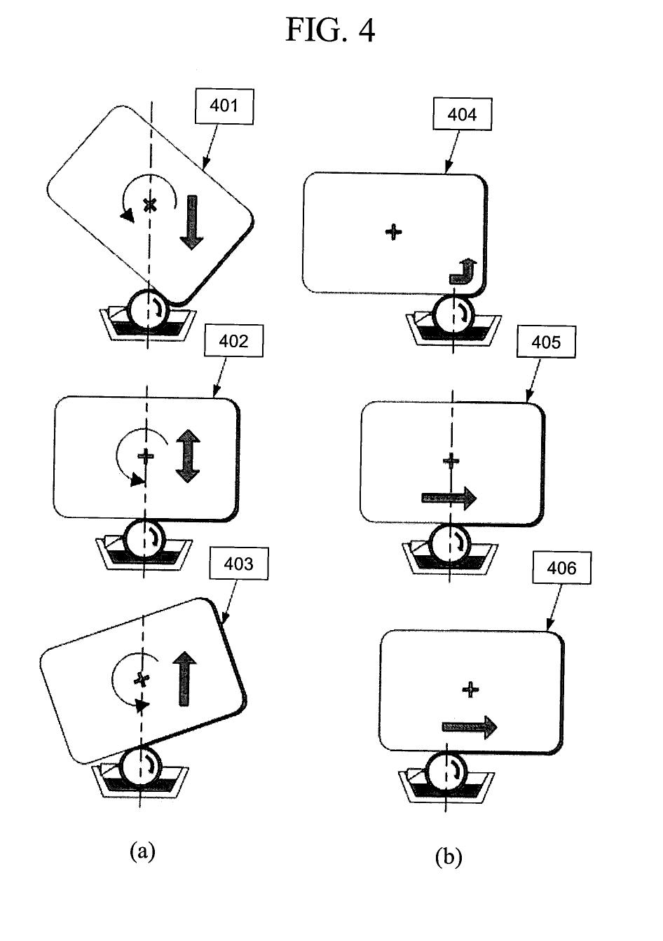

FIGS. 4a and 4b are schematic side views of coating station B in FIG. 3, showing possible modes of articulation of the glass article as the perimeter is coated according to method 200. FIG. 4a shows a coating process in which the entire perimeter of the glass article is articulated through the use of only vertical (linear) and rotational movements. In FIG. 4a, the progression of coating one long edge of the glass article from step 401 to step 403 is shown. FIG. 4b shows a corresponding glass position in which the glass is articulated using only one control point on the applicator/roller. This requires an additional horizontal linear axis movement from step 404 to step 406 to coat one long edge of the glass article.

Curing station C in FIG. 3 includes a curing unit 309 such as, for example, the UV spot-curing unit previously described hereinabove. In the embodiment shown in FIG. 3, the glass article 100 is rotated to expose the entire perimeter 115 of glass article 100 to the spot-curing unit and cure the coating material deposited on the at least one edge 110. Other types of curing mechanisms such a bar or flood lamps may also be used.

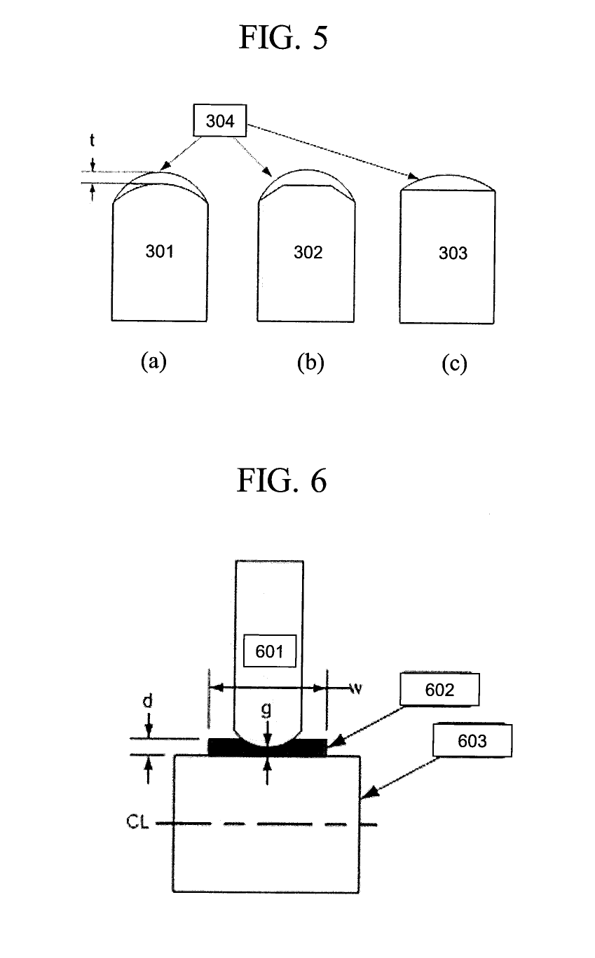

Side views of coatings 304 achieved using method 200 on bull nose 301, c-chamfered 302, and flat 303 edge profiles are schematically shown in FIGS. 5a, b, and c, respectively. As previously described herein, the application of coating 304 according to method 200 is not limited to these edge profiles, but may also be applied to other edge profiles. The thickness t of coating 304 is measured at the middle of the cross section 106 of glass article 100.

A side view of the method 200 for coating a glass article 501 having a bullnose edge profile is schematically shown in FIG. 6. In this instance, the applicator is a coating roller 503, which is rotated around axis CL. Coating material 602 is applied or metered onto) coating roller 603 to a specific, predetermined bead thickness d and, in some embodiments, a specific, predetermined width w. The relationship between glass article 601 and coating roller 603 is maintained at a predetermined or specified gap distance g during the coating of the entire perimeter of the glass article 601.

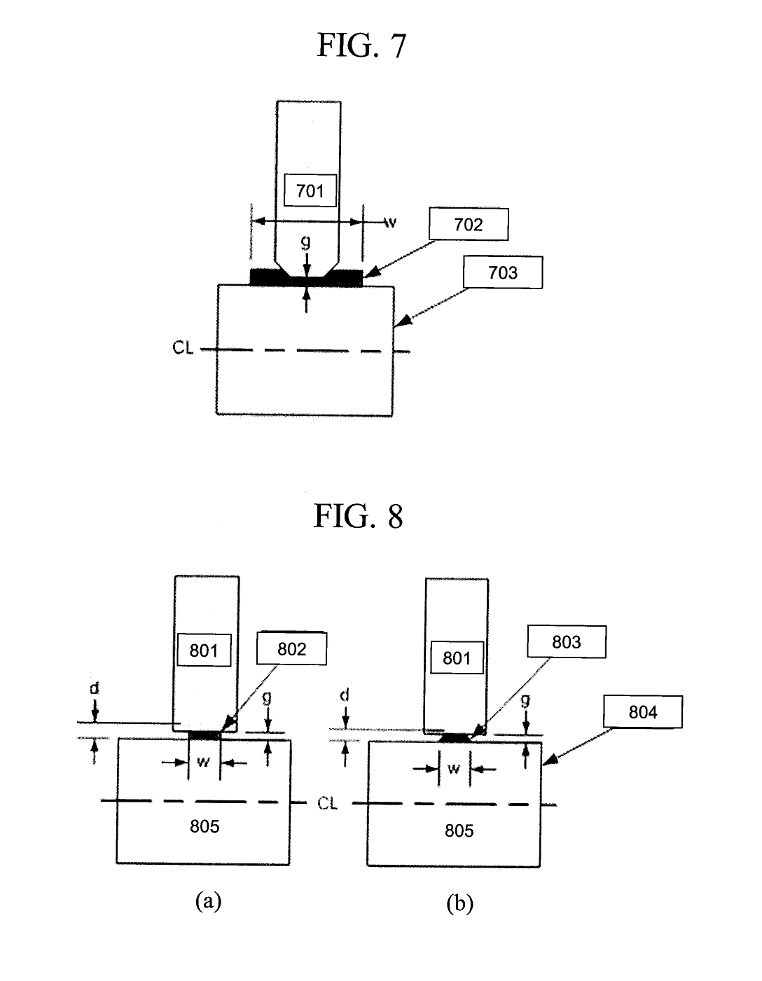

A side view of the method 200 for coating a glass article 701 having a c-chamfered edge profile is schematically shown in FIG. 7. Here, coating material 702 is applied or metered onto applicator/coating roller 703, which is rotated around axis CL to obtain a specific, predetermined bead thickness d and, in some embodiments, a specific, predetermined width w. The relationship between glass article 701 and coating roller 703 is maintained at a predetermined or specified gap distance g during the coating of the entire perimeter of the glass article 701.

FIGS. 8a and 8b are schematic side views of the method 200 for coating a glass article having a flat edge profile. In FIG. 8a, coating material 802 is applied or metered onto applicator/coating roller 805, which is rotated around axis CL to obtain a specific, predetermined bead thickness d and, in some embodiments, a specific, predetermined width w. The relationship between glass article 801 and coating roller 803 is maintained at a predetermined or specified gap distance g during the coating of the entire perimeter of the glass article 801. In order to prevent coating material 702 from flowing to the flat major surfaces of glass article 801, bead thickness w of the coating material 802 must be less than the thickness t of the glass article 801, as depicted by the metered coating material 802. In some embodiments, the shape of the bead of coating material 802 may be metered such that it presents a curved surface 803 or meniscus to the flat edge (FIG. 8b).

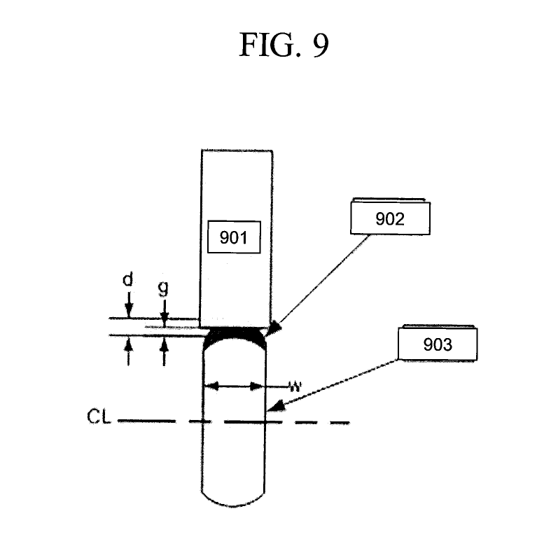

FIG. 9 is a schematic side view showing a second type of applicator/roller 903 for applying coating material 902 to a glass article 901 having a flat edge profile. Here, the applicator/roller 903 has a curved surface that presents a metered bead of coating material 902 that is capable of coating the flat edge without flowing to the flat major surfaces of glass article 901.

The coating systems and methods for coating the edges described hereinabove may be adapted to either contact the applicator or prevent contact with the applicator, and are capable of coating edges of glass articles of various sizes, thicknesses, shapes, and edge types. These coating systems and methods are also scalable. Since the perimeter of each article to be coated is, in some embodiments, characterized prior to coating, the methods described herein may be adjustable to accommodate variations in edge profile and perimeter that are present in the individual articles to be coated and are therefore are insensitive to article-to-article dimensional variations.

While typical embodiments have been set forth for the purpose of illustration, the foregoing description should not be deemed to be a limitation on the scope of the disclosure or appended claims. For example, the coating systems and methods described hereinabove may further include a closed loop feedback system using glass and coating data acquired before and after coating to characterize the perimeter and the coating applied thereto. Accordingly, various modifications, adaptations, and alternatives may occur to one skilled in the art without departing from the spirit and scope of the present disclosure or appended claims.

1. A method of coating at least one edge of at least one glass article, the at least one glass article having a first surface, a second surface and at least one edge joining the first surface and the second surface, the at least one edge defining the perimeter of the glass article, the method comprising:
applying a layer of the coating material to a surface of at least one applicator; contacting the at least one edge of the at least one glass article with the coating material on the surface; and
articulating at least one of the at least one glass article and the at least one applicator to coat the at least one edge with the coating material.

2. The method of claim 1, wherein the step of articulating at least one of the at least one glass article and the at least one applicator comprises continuously articulating the at least one glass article.

3. The method of claim 1, wherein the layer of the coating material has a thickness, and wherein contacting the at least one edge with the coating material comprises forming a predetermined gap between the at least one edge and the surface of the at least one applicator, wherein the predetermined gap is less than or equal to the thickness.

4. The method of claim 1, wherein the coating material is a curable resin.

5. The method of claim 4, further comprising curing the resin coating the at least one edge.

6. The method of claim 1, wherein the at least one edge has a chamfered profile, a bullnose profile, or a flat profile.

7. The method of claim 1, wherein articulating the at least one glass article comprises articulating the at least one glass article in at least one of a vertical direction and a horizontal direction with respect to the surface of the at least one applicator.

8. The method of claim 1, wherein articulating at least one of the at least one glass article and the at least one applicator comprises rotating the at least one glass article with respect to the surface of the at least one applicator.

9. The method of claim 1, further comprising articulating at least one of the at least one glass article and the at least one applicator along a linear axis.

10. The method of claim 1, further comprising determining a shape of the perimeter of the at least one glass article and articulating the at least one article based upon the shape.

11. The method of claim 1, wherein articulating at least one of the at least one glass article and the at least one applicator comprises articulating at least one of the at least one glass article and the at least one applicator by means of a pivoting arm.

12. The method of claim 1, wherein the at least one applicator comprises a rotatable roller.

13. The method of claim 1, wherein applying the layer of the coating material to the surface of the at least one applicator comprises metering the coating material that is applied to the surface of the at least one applicator.

14. The method of claim 13, wherein metering the coating material comprises doctor blading the coating material onto the surface of the at least one applicator.

15. The method of claim 1, wherein the at least one glass article comprises a plurality of glass articles, the plurality of stacked articles being stacked such that the first surfaces of the plurality of glass articles are parallel to each other.

16. The method of claim 15, wherein adjacent glass articles are separated by an interleaf material.

17. A method of coating an edge of at least one glass article with a curable resin, the at least one glass article having a first surface, a second surface and an edge joining the first surface and the second surface, the edge defining the perimeter of the at least one glass article, the method comprising:
determining a shape of the perimeter;
applying a layer of the curable resin to a surface of at least one applicator;
contacting the edge of the at least one glass article with the layer of the curable resin on the surface of the at least one applicator; and
continuously articulating at least one of the at least one glass article and the at least one applicator based upon the shape determined to coat the edge with the curable resin.

18. The method of claim 17, further comprising curing the curable resin coating the edge.

19. The method of claim 17, wherein the layer of the curable resin on the surface of the at least one applicator surface has a thickness, and contacting the edge with the curable resin comprises forming a predetermined gap between the edge and the surface of the at least one applicator, wherein the predetermined gap is less than or equal to the thickness.

20. The method of claim 17, wherein the edge has a chamfered profile, a bullnose profile, or a flat profile.

21. The method of claim 17, wherein articulating at least one of the at least one glass article and the at least one applicator comprises articulating the at least one glass article in at least one of a vertical direction and a horizontal direction with respect to the surface of the at least one applicator.

22. The method of claim 17, wherein articulating at least one of the at least one glass article and the at least one applicator comprises rotating the at least one glass article with respect to the surface of the at least one applicator.

23. The method of claim 17, further comprising articulating at least one of the at least one glass article and the at least one applicator along a linear axis.

24. The method of claim 17, wherein articulating at least one of the at least one glass article and the at least one applicator comprises articulating at least one of the at least one glass article and the at least one applicator by means of a pivoting arm.

25. The method of claim 17, wherein the at least one applicator comprises a rotatable roller.

26. The method of claim 17, wherein applying the layer of the coating material to the surface of the at least one applicator comprises metering the coating material that is applied to the surface of the at least one applicator.

27. The method of claim 24, wherein metering the coating material comprises doctor blading the coating material onto the surface of the at least one applicator.

28. The method of claim 17, wherein the at least one glass article comprises a plurality of glass articles, the plurality of stacked articles being stacked such that the first surfaces of the plurality of glass articles are parallel to each other.

29. The method of claim 28, wherein adjacent glass articles are separated by an interleaf material.

30. A system for depositing a coating on at least one edge of at least one glass article, the system comprising a coating application station, the application station comprising at least one applicator, wherein the at least one applicator has a surface that is adapted to hold a coating material; and
a holder adapted to hold and support the at least one glass article such that the at least one edge contacts the coating material, wherein at least one of the at least one applicator and the holder is capable of articulation in at least one of a horizontal direction, a vertical direction, and about an axis of rotation.

31. The system of claim 30, further comprising a visual inspection station for characterizing a perimeter of the glass article.

32. The system of claim 30, further comprising a curing station for curing the coating that is applied to the at least one edge.

33. The system of claim 30, wherein the at least one applicator is movable by means of a pivotal arm.

34. The system of claim 30, wherein the at least one applicator comprises a rotatable roller.

35. The system of claim 30, wherein the at least one applicator comprises a feed system for supplying the coating material to the at least one applicator and a doctor blade for metering an amount of the coating material provided to the at least one applicator.
